(19) United States
(12) Patent Application Publication
(10) Pub. No.: US 2026/0073569 A1
(43) Pub. Date: Mar. 12, 2026

(54) VOXEL-WISE CODING CONTROL METHOD FOR LOSSLESS POINT CLOUD COMPRESSION

(71) Applicant: InterDigital VC Holdings, Inc., Wilmington, DE (US)

(72) Inventors: Jiahao Pang, Plainsboro, NJ (US); Muhammad Asad Lodhi, Highland Park, NJ (US); Junghyun Ahn, New York, NY (US); Dong Tian, Boxborough, MA (US)

(21) Appl. No.: 18/830,379

(22) Filed: Sep. 10, 2024

(51) Int. Cl. G06T 9/00

(52) U.S. Cl. CPC G06T 9/001

(57) ABSTRACT

Some embodiments of a method may include: partitioning, into at least two groups, two or more voxels of a current level of point cloud data to be encoded; accessing already-encoded voxels of the current level; predicting probability distributions of a current voxel group in the current level based on the already-encoded voxels of the current level; accessing values of the current voxel group to be encoded; and encoding the values of the current voxel group into a bitstream based on the predicted probability distributions.

### INCORPORATION BY REFERENCE

The present application incorporates by reference in their entirety the following applications: U.S. Non-Provisional patent application Ser. No. 18/814,402, entitled “An End-To-End Learning-Based Point Cloud Attribute Coding Framework” and filed Aug. 23, 2024 (“'402 application”); U.S. Non-Provisional patent application Ser. No. 18/814,400, entitled “A Learning-Based Point Cloud Geometry Compression Framework” and filed Aug. 23, 2024 (“'400 application”); U.S. Non-Provisional patent application Ser. No. 18/784,466, entitled “End-to-End Learning-Based Dynamic Point Cloud Coding Framework” and filed Jul. 25, 2024 (“'466 application”).

### BACKGROUND

The present application is related to the field of point cloud compression and processing.

### SUMMARY

A first example method in accordance with some embodiments may include: partitioning, into at least two groups, two or more voxels of a current level of point cloud data to be encoded; accessing already-encoded voxels of the current level; predicting probability distributions of a current voxel group in the current level based on the already-encoded voxels of the current level; accessing values of the current voxel group to be encoded; and encoding the values of the current voxel group into a bitstream based on the predicted probability distributions.

For some embodiments of the first example method, the values of the current voxel group are associated with color attributes related to the current voxel group.

For some embodiments of the first example method, the values of the current voxel group are associated with reflectance attributes of LiDAR data related to the current voxel group.

For some embodiments of the first example method, predicting probability distributions may include: convolutionally encoding one or more features, wherein the one or more features are derived from the already-encoded voxels of the current level; and passing the convolutionally encoded features through a multi-layer perceptron (MLP) to generate the predicted probability distributions.

Some embodiments of the first example method may further include concatenating at least one of the one or more features with context information obtained from the already-encoded voxels.

For some embodiments of the first example method, encoding the values of the current voxel group into the bitstream includes encoding the values of the current voxel group into the bitstream with arithmetic encoding based on the predicted probability distributions.

For some embodiments of the first example method, partitioning, into at least two groups, the two or more voxels of the current level includes splitting the voxels into two or more groups based on an associated attribute of one of the voxels.

For some embodiments of the first example method, partitioning, into at least two groups, the two or more voxels of the current level includes splitting the voxels into two or more groups based on an occupancy status of one of the voxels or a parent voxel of one of the voxels.

For some embodiments of the first example method, partitioning, into at least two groups, the two or more voxels of the current level includes splitting the voxels into two or more groups based on position of the two or more voxels relative to a parent voxel.

Some embodiments of the first example method may further include: performing a repetitive encoding process one or more times, wherein the repetitive encoding process includes: predicting current probability distributions of the current voxel group in the current level based on the already-encoded voxels of the current level; accessing values of the current voxel group to be encoded; and encoding the values of the current voxel group into a current output bitstream based on the current predicted probability distributions.

A second example method in accordance with some embodiments may include: partitioning, into at least two groups, two or more voxels of a current level of point cloud data to be decoded; accessing already-decoded voxels of the current level; predicting probability distributions of a current voxel group in the current level based on the already-decoded voxels of the current level; accessing a bitstream for the current voxel group; and decoding values of the current voxel group based on the predicted probability distributions.

For some embodiments of the second example method, the values of the current voxel group are associated with color attributes related to the current voxel group.

For some embodiments of the second example method, the values of the current voxel group are associated with reflectance attributes of LiDAR data related to the current voxel group.

For some embodiments of the second example method, predicting probability distributions includes: convolutionally encoding one or more features, wherein the one or more features are derived from the already-encoded voxels of the current level; and passing the convolutionally encoded features through a multi-layer perceptron (MLP) to generate the predicted probability distributions.

For some embodiments of the second example method, decoding the values of the current voxel group includes decoding the values of the current voxel group with arithmetic decoding based on the predicted probability distributions.

For some embodiments of the second example method, partitioning, into at least two groups, the two or more voxels of the current level includes splitting the voxels into two or more groups based on an associated attribute of one of the voxels.

For some embodiments of the second example method, partitioning, into at least two groups, the two or more voxels of the current level includes splitting the voxels into two or more groups based on an occupancy status of one of the voxels or a parent voxel of one of the voxels.

For some embodiments of the second example method, partitioning, into at least two groups, the two or more voxels of the current level includes splitting the voxels into two or more groups based on position of the two or more voxels relative to a parent voxel.

Some embodiments of the second example method may further include: performing a repetitive decoding process one or more times, wherein the repetitive decoding process includes: predicting current probability distributions of the current voxel group in the current level based on the already-decoded voxels of the current level; accessing a current attribute bitstream for the current voxel group; and decoding current values of the current voxel group based on the current predicted probability distributions.

An example apparatus in accordance with some embodiments may include: a processor; and a memory storing instructions operative, when executed by the processor, to cause the apparatus to: partition, into at least two groups, two or more voxels of a current level of point cloud data to be decoded; access already-decoded voxels of the current level; predict probability distributions of a current voxel group in the current level based on the already-decoded voxels of the current level; access a bitstream for the current voxel group; and decode values of the current voxel group based on the predicted probability distributions.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example set of interfaces for a system according to some embodiments.

FIG. 1B is a schematic side view illustrating an example waveguide display that may be used with extended reality (XR) applications according to some embodiments.

FIG. 1C is a schematic side view illustrating an example alternative display type that may be used with extended reality applications according to some embodiments.

FIG. 1D is a schematic side view illustrating an example alternative display type that may be used with extended reality applications according to some embodiments.

FIG. 2 is a process diagram illustrating an example lossless point cloud coding in a tree-structure according to some embodiments.

FIG. 3 is a process diagram illustrating an example coding order in a traditional method with all voxels coded in one step according to some embodiments.

FIG. 4 is a process diagram illustrating an example traditional method for encoding of the current level of detail (LoD) with context modeling according to some embodiments.

FIG. 5 is a process diagram illustrating an example traditional method for decoding of the current LoD with context modeling according to some embodiments.

FIG. 6 is a process diagram illustrating an example lossless coding of point cloud geometry in a tree-structure according to some embodiments.

FIG. 7 is a process diagram illustrating an example coding order in a traditional method for geometry with all voxels coded in one step according to some embodiments.

FIG. 8 is a process diagram illustrating an example coding order with voxels coded in multiple steps according to some embodiments.

FIG. 9 is a process diagram illustrating an example coding order in a traditional method for geometry with voxels coded in multiple steps according to some embodiments.

FIG. 10 is a process diagram illustrating an example encoding of the current LoD in multiple steps with context modeling according to some embodiments.

FIG. 11 is a process diagram illustrating an example decoding of the current LoD in multiple steps with context modeling according to some embodiments.

FIG. 12 is a process diagram illustrating an example channel-wise coding with grouping of all voxels from a channel in one step according to some embodiments.

FIG. 13 is a process diagram illustrating an example attribute encoding according to some embodiments.

FIG. 14 is a process diagram illustrating an example attribute decoding according to some embodiments.

FIG. 15 is a process diagram illustrating an example feature aggregator according to some embodiments.

FIG. 16A is a process diagram illustrating an example feature encoder according to some embodiments.

FIG. 16B is a process diagram illustrating an example feature decoder according to some embodiments.

FIG. 17 is a process diagram illustrating an example attribute probability estimator according to some embodiments.

FIG. 18 is a process diagram illustrating an example application to attribute encoding according to some embodiments.

FIG. 19 is a process diagram illustrating an example application to attribute decoding according to some embodiments.

FIG. 20 is a process diagram illustrating an example updated attribute probability estimator according to some embodiments.

FIG. 21 is a flowchart illustrating an example encoding process according to some embodiments.

FIG. 22 is a flowchart illustrating an example decoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

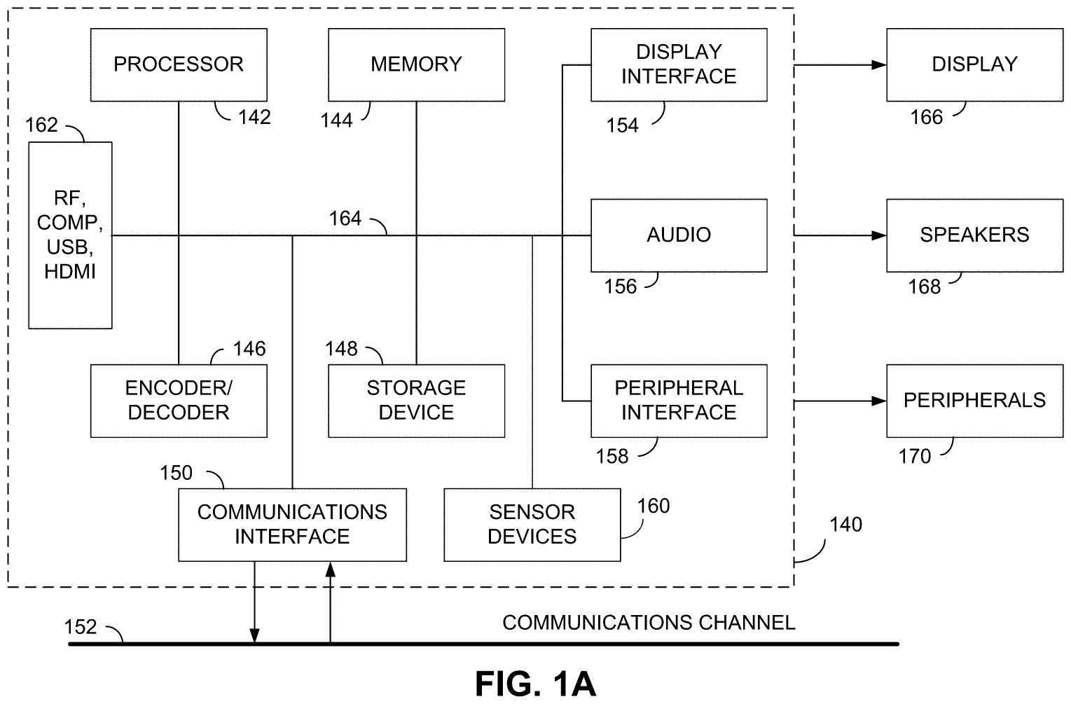

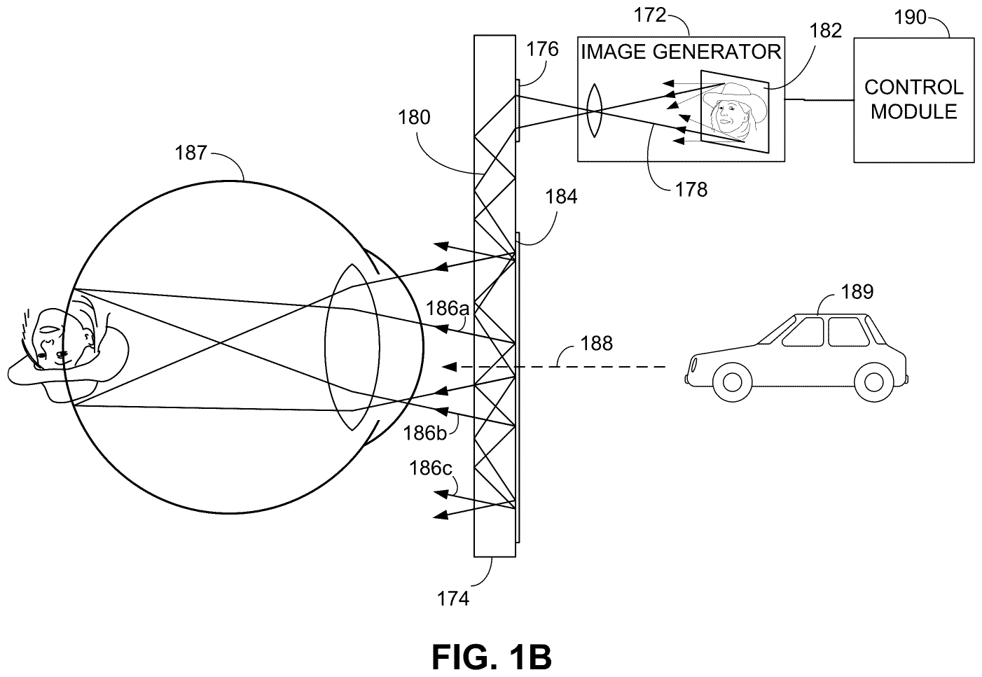

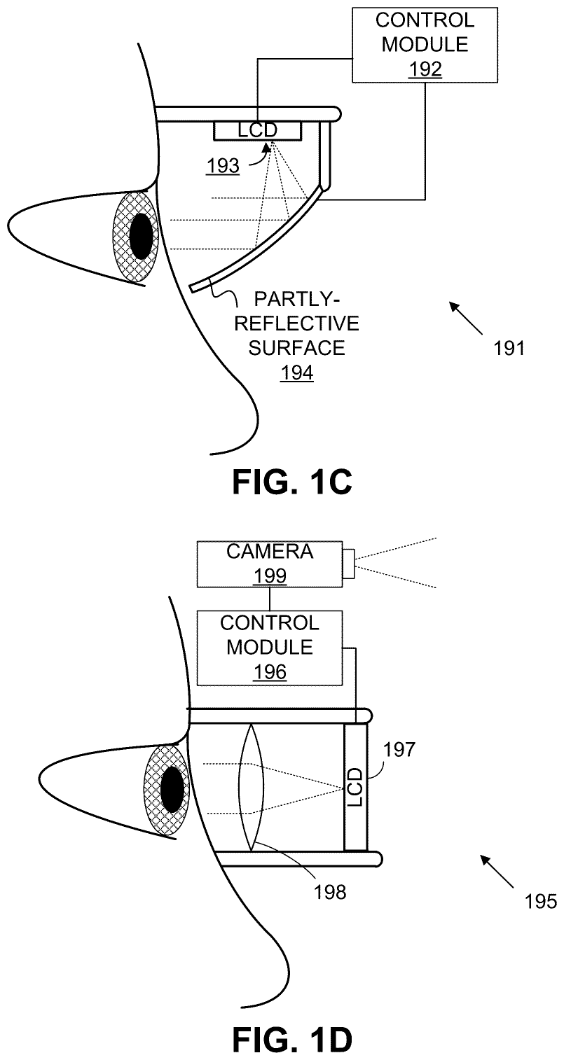

FIG. 1A is a system diagram illustrating an example set of interfaces for a system according to some embodiments. An extended reality display device, together with its control electronics, may be implemented using a system such as the system of FIG. 1A. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1A, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (I2C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV. Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

### Scene Description Framework for XR

In some embodiments, examples disclosed herein may be used in the domain of rendering of extended reality scene description and extended reality rendering. For some embodiments, for example, the present application may be applied in the context of the formatting and the playing of extended reality applications when rendered on end-user devices such as mobile devices or Head-Mounted Displays (HMD). For some example embodiments, glTF material may be rendered in a 3D environment that is rendered through a 2D screen. The examples presented herein in accordance with some embodiments are not limited to XR applications.

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology—Coded representation of immersive media—Part 14: Scene Description for MPEG media, ISO/IEC DIS 23090-14: 2021 (E). A scene update mechanism based on the JSON Patch protocol as defined in IETF RFC 6902 may be used to synchronize virtual content to MPEG media streams.

FIG. 1B is a schematic side view illustrating an example waveguide display that may be used with extended reality (XR) applications according to some embodiments. An image is projected by an image generator 172. The image generator 172 may use one or more of various techniques for projecting an image. For example, the image generator 172 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 182 generated by the image generator 172 is coupled into a waveguide 174 by a diffractive in-coupler 176. The in-coupler 176 diffracts the light representing the image 182 into one or more diffractive orders. For example, light ray 178, which is one of the light rays representing a portion of the bottom of the image, is diffracted by the in-coupler 176, and one of the diffracted orders 180 (e.g. the second order) is at an angle that is capable of being propagated through the waveguide 174 by total internal reflection. The image generator 172 displays images as directed by a control module 190, which operates to render image data, video data, point cloud data, or other displayable data.

At least a portion of the light 180 that has been coupled into the waveguide 174 by the diffractive in-coupler 176 is coupled out of the waveguide by a diffractive out-coupler 184. At least some of the light coupled out of the waveguide 174 replicates the incident angle of light coupled into the waveguide. For example, in the illustration, out-coupled light rays 186a, 186b, and 186c replicate the angle of the in-coupled light ray 178. Because light exiting the out-coupler replicates the directions of light that entered the in-coupler, the waveguide substantially replicates the original image 182. A user's eye 187 can focus on the replicated image.

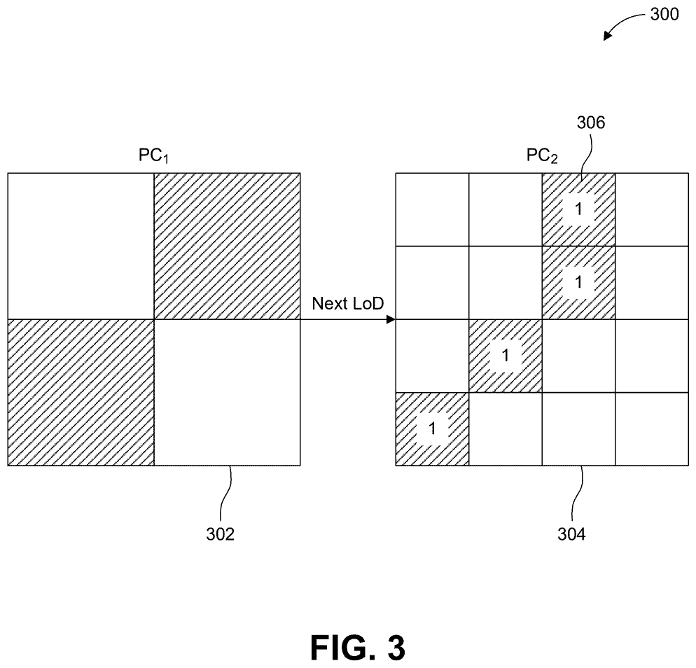

In the example of FIG. 1B, the out-coupler 184 out-couples only a portion of the light with each reflection allowing a single input beam (such as beam 178) to generate multiple parallel output beams (such as beams 186a, 186b, and 186c). In this way, at least some of the light originating from each portion of the image is likely to reach the user's eye even if the eye is not perfectly aligned with the center of the out-coupler. For example, if the eye 187 were to move downward, beam 186c may enter the eye even if beams 186a and 186b do not, so the user can still perceive the bottom of the image 182 despite the shift in position. The out-coupler 184 thus operates in part as an exit pupil expander in the vertical direction. The waveguide may also include one or more additional exit pupil expanders (not shown in FIG. 3A) to expand the exit pupil in the horizontal direction.

In some embodiments, the waveguide 174 is at least partly transparent with respect to light originating outside the waveguide display. For example, at least some of the light 188 from real-world objects (such as object 189) traverses the waveguide 174, allowing the user to see the real-world objects while using the waveguide display. As light 188 from real-world objects also goes through the diffraction grating 184, there will be multiple diffraction orders and hence multiple images. To minimize the visibility of multiple images, it is desirable for the diffraction order zero (no deviation by 184) to have a great diffraction efficiency for light 188 and order zero, while higher diffraction orders are lower in energy. Thus, in addition to expanding and out-coupling the virtual image, the out-coupler 184 is preferably configured to let through the zero order of the real image. In such embodiments, images displayed by the waveguide display may appear to be superimposed on the real world.

FIG. 1C is a schematic side view illustrating an example alternative display type that may be used with extended reality applications according to some embodiments. In an XR head-mounted display device 191, a control module 192 controls a display 193, which may be an LCD, to display an image. The head-mounted display includes a partly-reflective surface 194 that reflects (and in some embodiments, both reflects and focuses) the image displayed on the LCD to make the image visible to the user. The partly-reflective surface 194 also allows the passage of at least some exterior light, permitting the user to see their surroundings.

FIG. 1D is a schematic side view illustrating an example alternative display type that may be used with extended reality applications according to some embodiments. In an XR head-mounted display device 195, a control module 196 controls a display 197, which may be an LCD, to display an image. The image is focused by one or more lenses of display optics 198 to make the image visible to the user. In the example of FIG. 1D, exterior light does not reach the user's eyes directly. However, in some such embodiments, an exterior camera 199 may be used to capture images of the exterior environment and display such images on the display 197 together with any virtual content that may also be displayed.

The embodiments described herein are not limited to any particular type or structure of XR display device.

A User Equipment (UE) may correspond to any eXtended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

This disclosure belongs to the field of point cloud compression and processing. This field aims to develop tools for compression, analysis, interpolation, representation and understanding of point cloud signals.

Point cloud data is a universal data format across several business domains from autonomous driving, robotics, AR/VR, civil engineering, computer graphics, to the animation /ovie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when the storage and transmission of the data are used in related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the applications. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer as opposed to standard TV in which the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects, like statues or buildings, are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

### General Challenges

3D point cloud data include discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data may be composed of two components: geometry information and attribute information, the compression of point clouds may be classified into two categories: geometry coding and attribute coding. This work is a learning-based technology for lossless point cloud compression that may be applied to both point cloud geometry compression and attribute compression.

The main challenge when using a learning-based method for lossless point cloud coding is how to effectively estimate the attribute probability distribution. With higher accuracy of the estimated probabilities, the arithmetic coding of the attribute value or the occupancy information of a voxel uses less bits. In traditional learning-based methods to losslessly encode a point cloud, computing probabilities for the voxels at a current level, the probabilities of all the voxels may be computed at once. This is a less efficient way to utilize the correlation among voxels, resulting in a larger bitstream size. This is the problem to be resolved in this work.

Below is a description of a traditional technique for lossless voxel-based point cloud coding represented in an octree structure with a focus on attribute coding. For some embodiments, geometry coding may be viewed as a special case of attribute coding where the attributes are binary—either occupied (0) or empty (1).

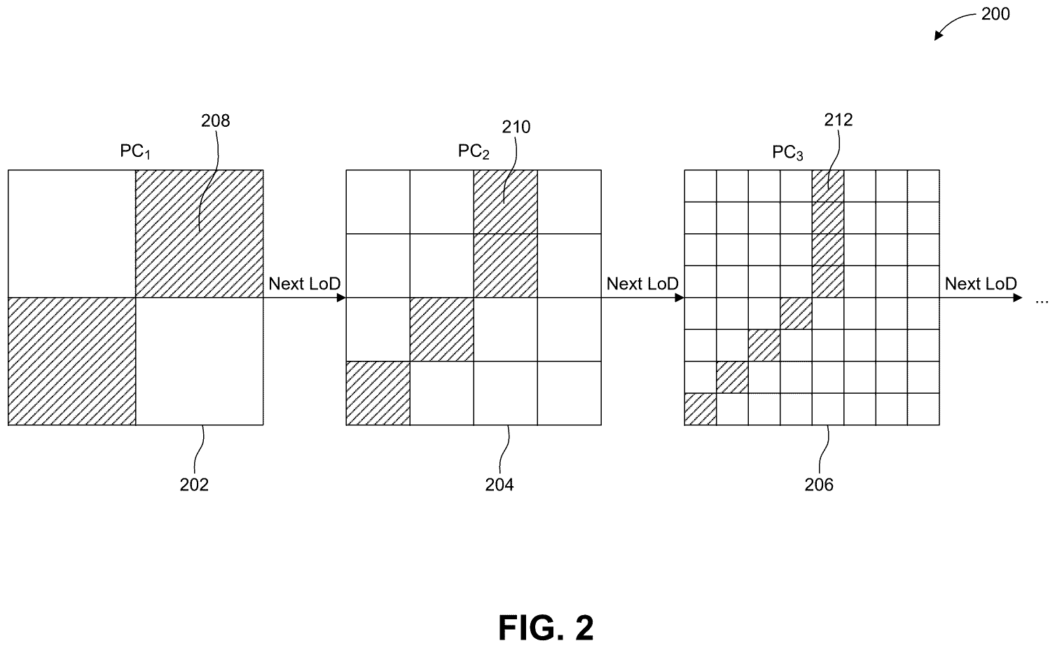

FIG. 2 is a process diagram illustrating an example lossless point cloud coding in a tree-structure according to some embodiments. To encode/decode a point cloud represented in an octree structure, the first level of detail (LoD) 202 of the octree is traversed all the way to the last LoD 206 of the octree. See FIG. 2. In FIG. 2 (and the others), 2-D examples are used just for illustration. When processing a particular level, the encoding/decoding of the current LoD is performed based on all the known information—either from the previously coded voxels or from other side information. Without loss of generality, this application focuses on the coding of the second level 204 (denoted as PC₂) and looks at attribute coding as the example. In the example process 200, occupied locations 208, 210, 212 are shown as examples.

### Encoder

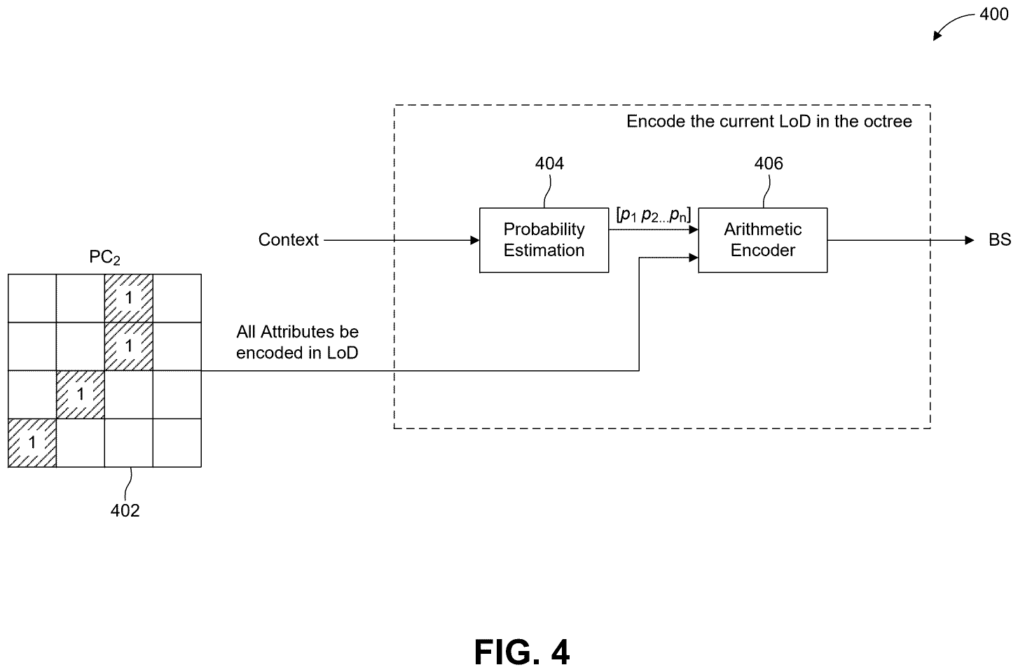

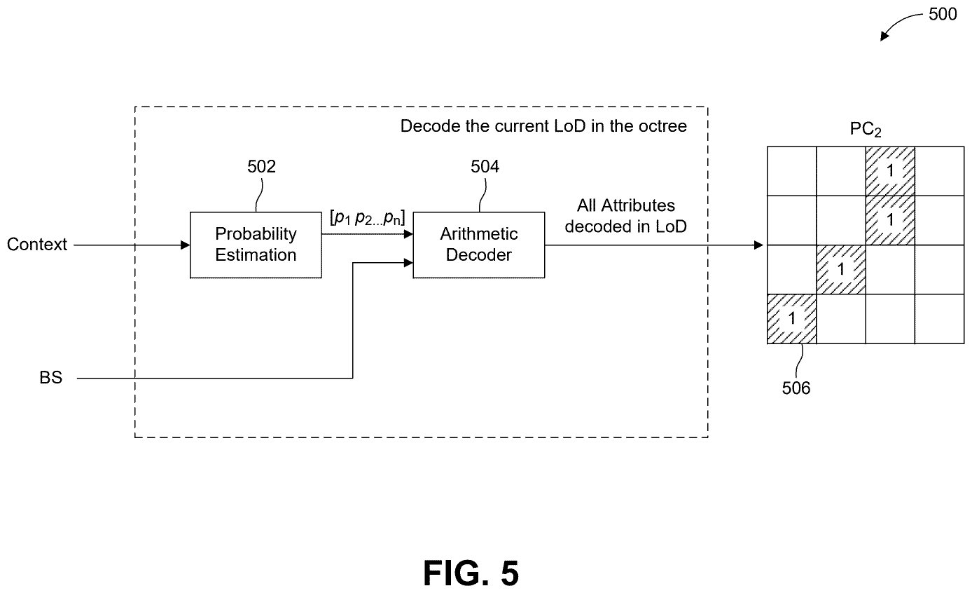

FIG. 3 is a process diagram illustrating an example coding order in a traditional method with all voxels coded in one step according to some embodiments. To code the contents of each voxel in PC₂ (304), a traditional method 300 computes the probability distributions of the attributes for the voxels in one step simultaneously, as shown in FIG. 3 (“1” (306) means step one in FIG. 3). This method 300 also shows moving from a first level of detail (LoD) for PC₁ (302) to a second level of detail for PC₂ (304). Encoding and decoding diagrams are provided in FIGS. 4 and 5.

FIG. 4 is a process diagram illustrating an example traditional method for encoding of the current LoD with context modeling according to some embodiments. Suppose there are n attribute values 402 to be encoded. Then, on the encoder side 400 (FIG. 4), given the context from the previously already encoded voxels of the previous LoD, a probability estimation block 404 computes the probability distributions of all of these n attribute values in one step. This probability estimate leads to the probability distributions of each of the attribute values [p₁, p₂, . . . , pₙ], in which each of the pᵢ is an M-dimensional vector that sums up to one. The probability estimation block 404 is a block based on neural networks. For color attribute ranging from 0 to 255, M is 256. When the reflectance of LiDAR ranges from 0 to 99, M is 100. In the case of coding geometry in which the values are binary, M is 2. The arithmetic encoder 406 takes all n input values and encodes them losslessly with the assistant of the estimated probability distributions. The arithmetic encoder 406 outputs the bitstream in the end.

### Decoder

FIG. 5 is a process diagram illustrating an example traditional method for decoding of the current LoD with context modeling according to some embodiments. On the decoder side 500, the probability estimation block 502 takes the context information from the previously-encoded voxels of the previous LoD and computes the probability distributions of each of the attribute values [p₁, p₂, . . . , pₙ]. The arithmetic decoder 504 takes the input bitstream and decodes all n attribute values 506 in one step. This arithmetic decoding process 504 is assisted by the estimated probability distributions [p₁, p₂, . . . , pₙ].

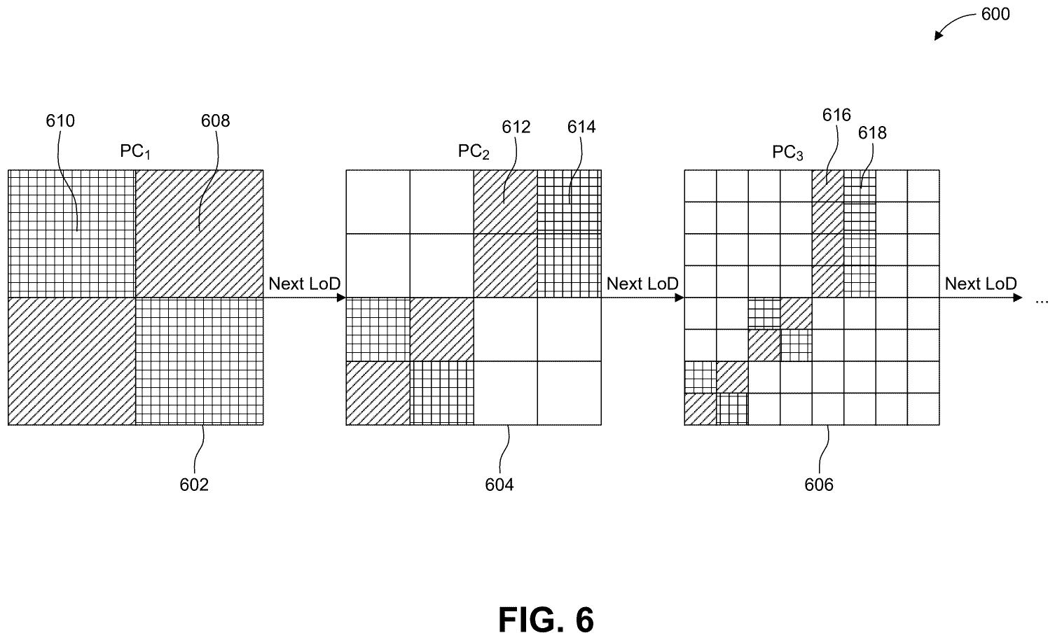

FIG. 6 is a process diagram illustrating an example lossless coding of point cloud geometry in a tree-structure according to some embodiments. When dealing with geometry coding, the steps are similar, as shown in FIG. 6, the first LoD 602 is traversed all the way to the last LoD 606 of the octree. In the process 600 of FIG. 6, diagonal-line shading indicates occupied voxels 608, 612, 616. Grid-line shaded voxels and white voxels are empty voxels. The grid-line shaded voxels 610, 614, 618 are empty voxels that need to be encoded/decoded at the associated level.

At each level 602, 604, 606, there is encoding of the occupancy values of those voxels whose parents are occupied. Thus, for each LoD 602, 604, 606, the encoding of the geometry is the same as the encoding of the attribute(s). The only difference is that, for geometry coding, values to be coded are binary, which indicates the occupancy status of the voxels.

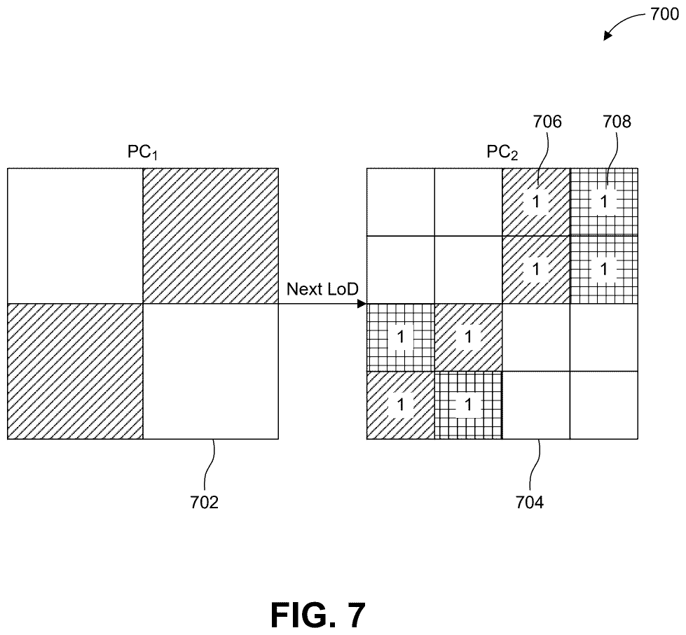

FIG. 7 is a process diagram illustrating an example coding order in a traditional method for geometry with all voxels coded in one step according to some embodiments. With the traditional design 700, all of the voxels of the current LoD 704 are coded at once. See FIG. 7 for an illustrative example (“1” (706, 708) means step one in FIG. 7). This method 700 also shows moving from a first level of detail (LoD) for PC₁ (702) to a second level of detail for PC₂ (704). In the process 700 of FIG. 7, diagonal-line shading indicates occupied voxels 706, while grid-line shaded voxels 708 and white voxels are empty voxels.

### Limitation

For some embodiments, the core of having an effective lossless octree coder is to have better probability estimation. However, the traditional method, as understood, has a major limitation in that the traditional method estimates the probability distributions of all of the voxels simultaneously. Also, as understood, there is no way to use any sibling information in the current LoD to assist the probability estimation process. In other words, the inter-voxel correlations are not utilized in this design, which may lead to sub-optimal performance. This issue is to be resolved by the present application. Instead of coding all the voxels at the current LoD in only one step, this coding process may be split into multiple steps to better utilize the correlation among neighboring voxels.

### Overall Design

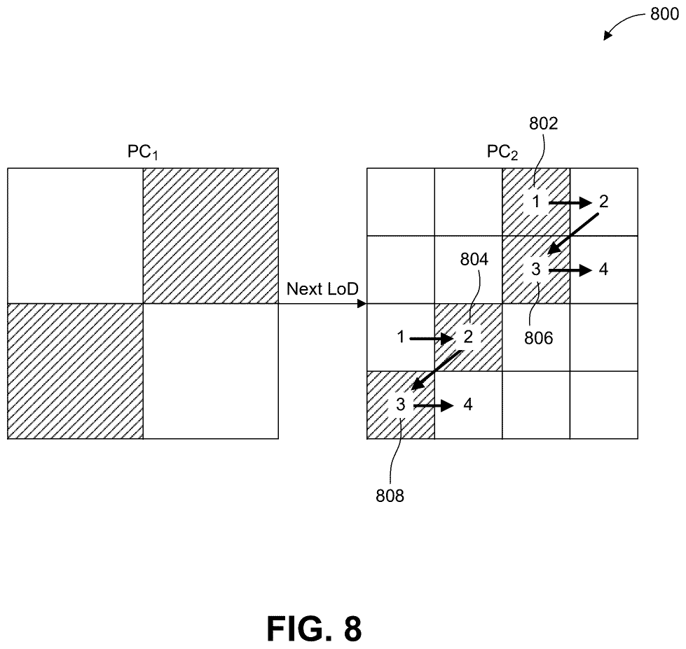

FIG. 8 is a process diagram illustrating an example coding order with voxels coded in multiple steps according to some embodiments. To code the voxels of an LoD, a multi-step process 800 may be used. Particularly, the voxels may be classified into several groups according to their positions relative to their parents. Thus, in 2D, there are 4 groups, while, in 3D, there are 8 groups.

Rather than coding all the groups at one time, coding may occur in more than one step. Therefore, the groups that are coded later may use the earlier coded groups at the same LoD to estimate the probabilities. This process may lead to more precise probability estimation and a smaller bitstream.

In the example process 800 of FIG. 8, one group is coded at one time, leading to a voxel-by-voxel coding approach. In this attribute coding example of FIG. 8, certain steps for the empty voxels may be skipped. In this particular example, the occupied voxel labeled as “1” (802) is coded first. Then, the process 800 proceeds to the occupied voxel labeled as “2” (804). Then, the process 800 codes the two occupied voxels labeled as “3” (806, 808). Since there is no occupied voxel labeled as “4”, the fourth step is skipped in this example.

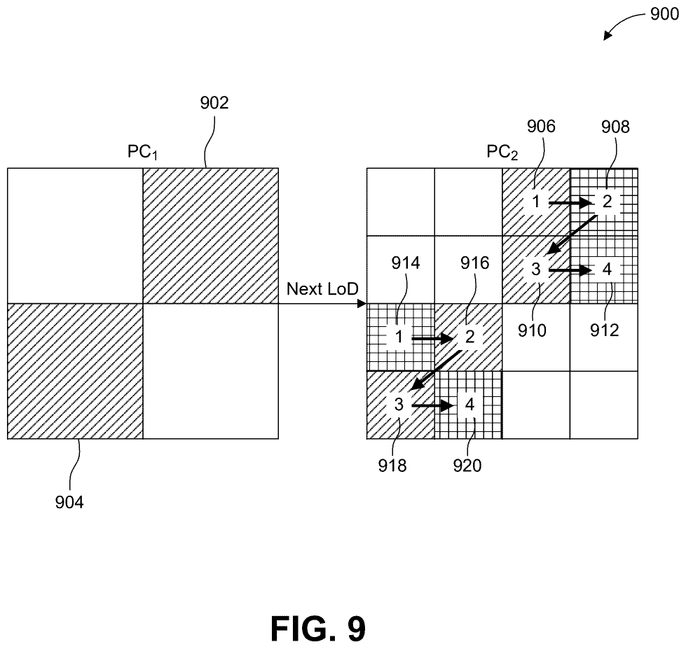

FIG. 9 is a process diagram illustrating an example coding order in a traditional method for geometry with voxels coded in multiple steps according to some embodiments. When coding the geometry as shown in FIG. 9, the rationale is the same. The only difference is that all the voxels with parents occupied need to be encoded, even if a voxel itself is empty.

In the example process 900, parent voxels (902, 904) are occupied. Hence, the associated child voxels are encoded. The voxels labeled as “1” (906, 914) are coded first. Then, the process 900 proceeds to the voxels labeled as “2” (908, 916). Then, the process 900 codes the voxels labeled as “3” (910, 918). Then, the process 900 codes the voxels labeled as “4”(912, 920).

### Encoder

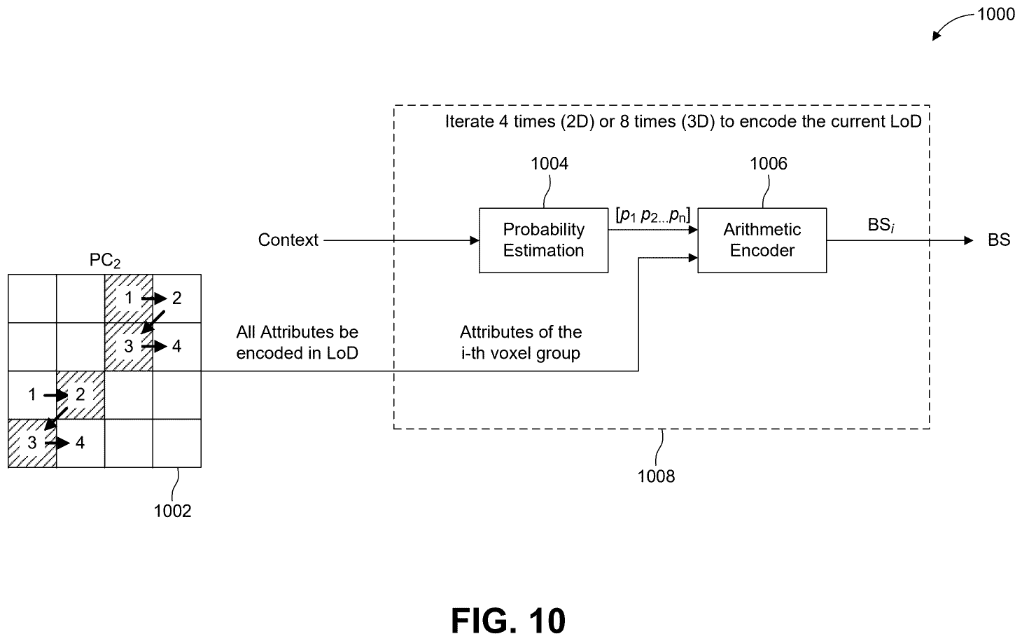

FIG. 10 is a process diagram illustrating an example encoding of the current LoD in multiple steps with context modeling according to some embodiments. An encoder process 1000 is provided in FIG. 10. Instead of performing a one-step coding of a traditional design, the process 1000 iterates more than one time to complete the encoding.

If a voxel-by-voxel approach is used, the process 1000 ends up with an 8-step coding process for 3D. In i-th step, the goal is to encode the i-th group of voxels. Suppose there are k voxels in the i-th group. An access is made for the context information from not only the parent LoD but also the voxels in the current LoD that has already been encoded. The process 1000 uses this context information to perform probability distribution estimation 1004 of the current group, which are denoted as [p₁, p₂, . . . , pₖ]. After that, arithmetic encoding 1006 of the voxel attributes is performed based on the estimated probability distributions [p₁, p₂, . . . , pₖ], leading to the output sub-bitstream BSᵢ for the i-th step. The bitstream for the current LoD is obtained by aggregating all the sub-bitstreams.

### Decoder

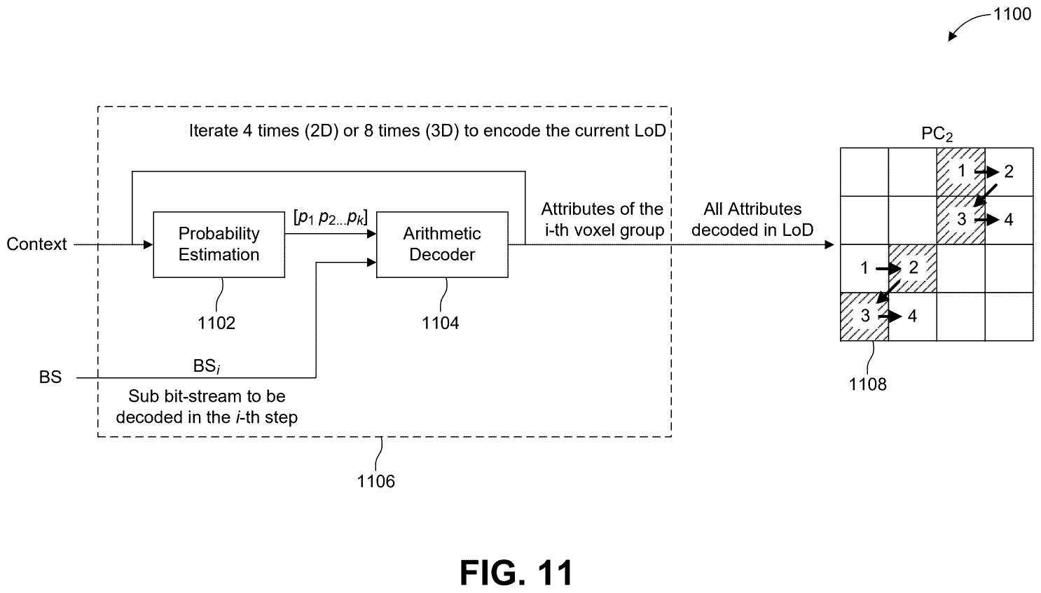

FIG. 11 is a process diagram illustrating an example decoding of the current LoD in multiple steps with context modeling according to some embodiments. The decoder design 1100 follows the same rationale to iteratively decode the voxel groups, in the way as its corresponding encoder. The decoder design is provided in FIG. 11. Instead of performing one-step coding of a traditional design, the process 1100 iterates more than one time to accomplish the decoding.

For some embodiments, a voxel-by-voxel decoding uses 8 steps to accomplish the entire decoding process. In the i-th step, the goal is to decode the i-th group of the voxels. An access is performed for the context information from not only the parent LoD but also the already-decoded voxels in the current LoD. The process 1100 uses this context information to perform probability distribution estimation 1102 of the current voxel group to be decoded. In this way, the probability distributions [p₁, p₂, . . . , pₖ] are the same as the ones used on the encoder side. After that, arithmetic decoding 1104 of the sub-bitstream BSᵢ is performed for the current voxel group based on the estimated probability distributions [p₁, p₂, . . . , pₖ]. This process leads to the decoded attributes 1108 of the i-th voxel group. The attributes of the current LoD may be obtained by aggregating the decoded attributes of all the voxel groups.

The encoding and decoding of the geometry follows the same rationale as before, where instead of encoding all 8 voxels simultaneously, the coding process is split into several steps. The way the voxel groups are partitioned on the decoder needs to be exactly the same as the associated encoder. In other words, such partitioning should be known by the decoder in order to decode a bitstream. In some embodiments, the voxel group partitioning information may be sent to the decoder as a syntax element in the high-level syntax.

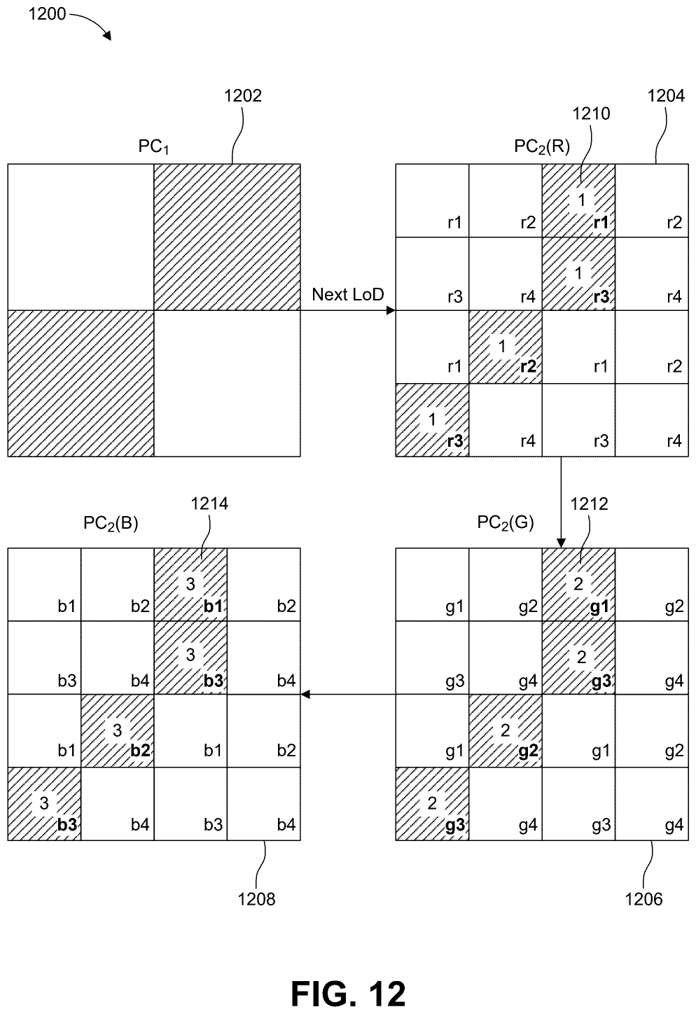

FIG. 12 is a process diagram illustrating an example channel-wise coding with grouping of all voxels from a channel in one step according to some embodiments. In some embodiments, when coding the color attributes (either in RGB or YUV or other color space), the goal is to encode/decode the three-channel (e.g., R, G and B) information for each voxel. In this scenario, there are 8×3=24 groups to be coded. The groups are denoted as {r1, r2, r3, . . . , r8}, {g1, g2, g3, . . . , g8}, and {b1, b2, . . . , b8}. In the grouping shown in FIG. 12, which is a 2-D example, there are 12 voxel groups: {r1, r2, r3, r4}, {g1, g2, g3, g4}, and {b1, b2, b3, b4}.

Thus, at most, the entire coding process of the current LoD is split into 24 steps. In some embodiments, the coding process corresponds to the coding order: r1, r2, ..., r8, g1, g2, . . . , g8, b1, b2, . . . , b8. In this case, the inter-channel correlation as well as the spatial correlation are very well exploited for probability estimation. However, the computational cost may be high because 24 iterations are needed.

In some embodiments, an entire color channel may be encoded in one step/iteration. With such a process, 3 steps total are used to code an octree level. This example process 1200 is illustrated in FIG. 12. In the first step, all red channel values (labeled as “1”) 1210 for the red channel 1204 are coded. Next, all green channel values (labeled as “2”) 1212 for the green channel 1206 are coded. Then at last, all blue channel values (labeled as “3”) 1214 for the blue channel 1208 are coded.

In some embodiments, every m voxel groups are encoded in one coding step. For example, if 4 voxel groups are coded in one step, then the process corresponds to the coding order of (r1, r2, r3, r4), (r5, r6, r7, r8), (g1, g2, g3, g4), (g5, g6, g7, g8), (b1, b2, b3, b4), and (b5, b6, b7, b8). In this scenario, all voxel groups in a bracket are coded in one step. This case ends up with having 6 steps total to code one octree level.

In some embodiments, other coding orders may be selected, e.g., (r1, g1, b1), (r2, g2, b2), (r3, g3, b3), . . . , (r8, g8, b8). This selection is to mainly exploit the spatial correlation rather than exploiting the inter-channel correlation. This selection ends up with having 8 steps in total to code one octree level.

This design may be applied to the coding of other attributes that having multiple attribute values in one voxel, e.g., surface normal with contains 3 numbers. Furthermore, this design may be applied to the '402 application. The '402 application is briefly described, and then there is a description of how to apply the present design to the '402 application.

In a nutshell, to encode/decode an attribute of a current octree level, the '402 application extracts a finer-level or current-level feature and uses this feature to assist the probability estimation. Since the feature contains finer-level (or current-level) information, the probability estimation may be more accurate and the overall bitstream size may be reduced.

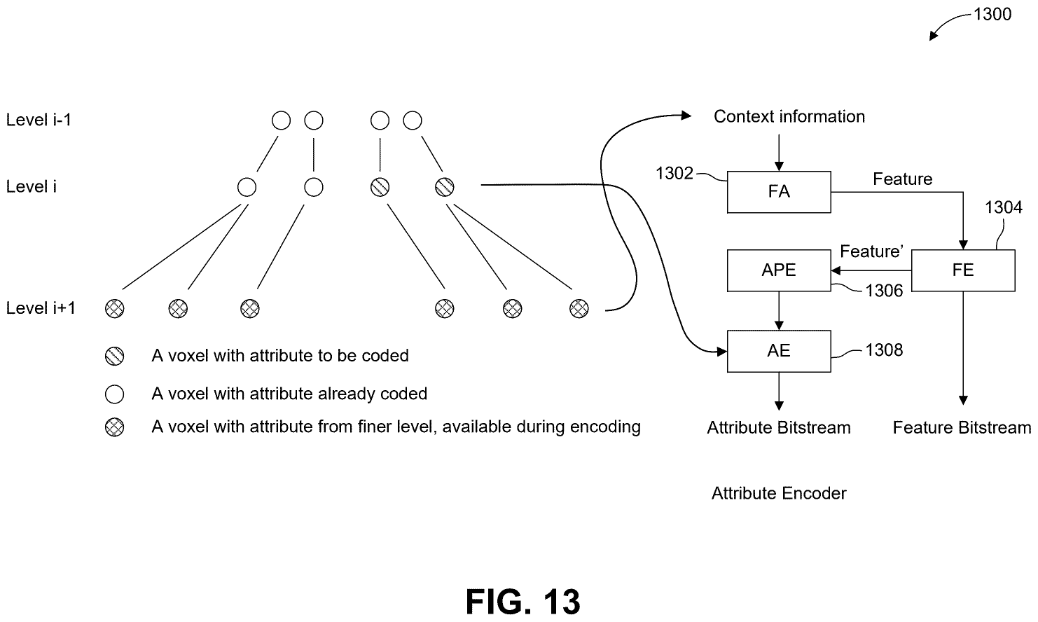

FIG. 13 is a process diagram illustrating an example attribute encoding according to some embodiments. The encoding method of the '402 application s illustrated in FIG. 13. There are four steps in this encoding method.

Step 1 of the process 1300 is a feature extractor/aggregator (FA) 1302. Unlike the feature extractor of some previous methods, where the input is from its parent level, the feature extractor/aggregator of the '402 application uses the finer (child) level of details as its input. Because the finer level of voxels always have more detailed information compared to voxels from a parent level, extraction of more representative features is easier.

Step 2 is a feature encoder (FE) 1304. The features generated from Step 1 are encoded into bitstreams. In addition to generating the bitstream, the feature encoder 1304 also outputs the reconstructed feature, which may not be exactly the same as the feature from Step 1. In some embodiments, the reconstructed feature (labeled as “Feature′”) is a quantized/dequantized version of the feature (labeled as “Feature ”) from Step 1. The reconstructed feature may match the decoded features on a decoder.

Step 3 is an attribute probability estimator (APE) 1306 using a neural network model. The APE 1306 takes the reconstructed feature as its input and computes the attribute probability distribution of a current octree voxel.

Step 4 is an arithmetic encoder (AE) 1308. Based on the estimated probability, the arithmetic encoder 1308 encodes the attribute information of the current octree voxels into a bitstream.

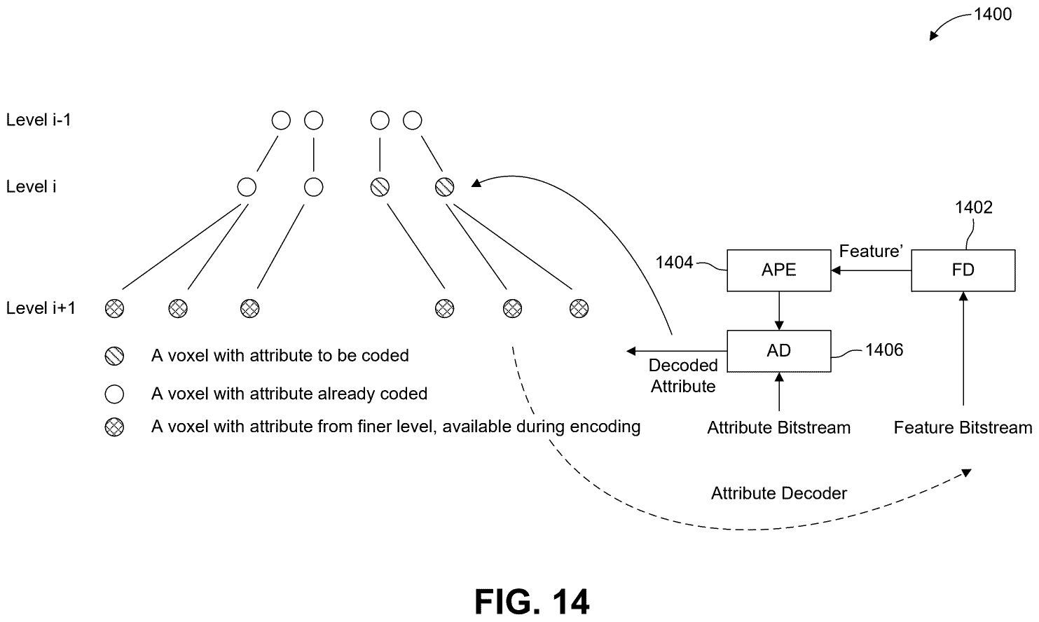

FIG. 14 is a process diagram illustrating an example attribute decoding according to some embodiments. The decoding method of the '402 application corresponds to the encoding method as illustrated in FIG. 14. There are three steps in the decoding method of the '402 application.

Step 1 of the process 1400 is a feature decoder (FD) 1402. The feature decoder 1402 decodes a feature (labeled as “Feature′”) from the input bitstream. The decoder relies on a coded feature rather than extraction of the feature from scratch. The decoder benefits from a more representative feature because the features were extracted using a finer level of details than from the parent level of the previous method.

Step 2 is an attribute probability estimator (APE) 1404. This step is the same as Step 3 in the encoding method in FIG. 13. The attribute probability estimator 1404 computes an attribute probability of a next octree voxel.

Step 3 is an arithmetic decoder (AD) 1406. Based on the estimated probability, the arithmetic decoder 1406 determines the attribute values of the next octree voxel.

### Feature Aggregator (FA)

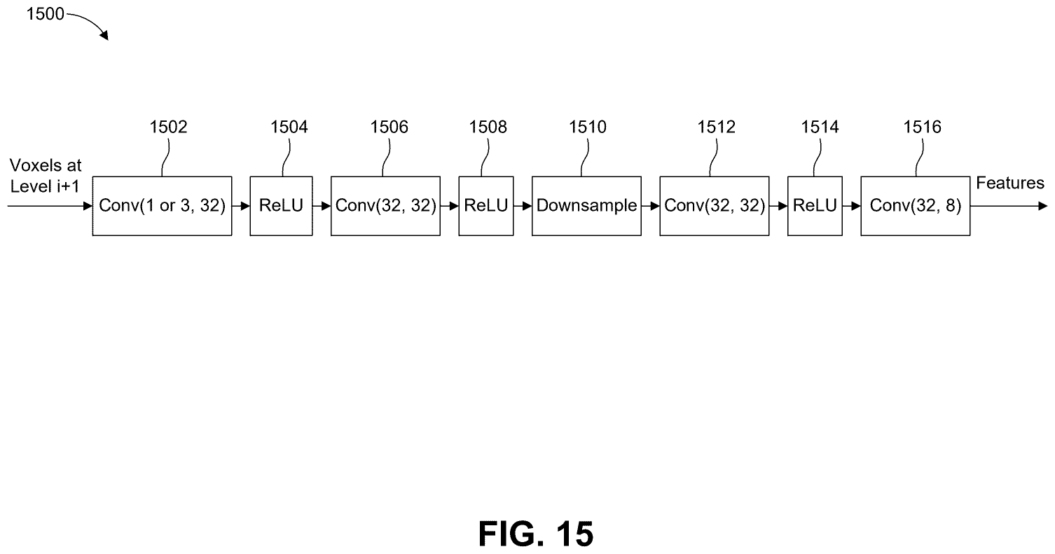

FIG. 15 is a process diagram illustrating an example feature aggregator according to some embodiments. An example design 1500 of the feature aggregator (FA) is shown in FIG. 15. In this case, the feature extractor takes the immediate next level of voxel with attributes as an input to extract features.

The example design 1500 of the feature aggregator (FA) is composed of several 3D convolutional layers 1502, 1506, 1512, 1516, down-sampling 1510, and several rectifier linear unit (ReLU) blocks 1504, 1508, 1514. The term “Conv(x, y)” means that the input feature channel size is x while the output feature channel size is y. The “Downsample”block 1510 downsamples the feature from (i+1)-th to the i-th level.

In some embodiments, the convolutional layers 1502, 1506, 1512, 1516 may be replaced with feature aggregation blocks, such as an Inception ResNet (IRN) block, and a Voxel Transformer block. These blocks may be repeated several times to enhance the feature aggregation performance. The input to the FA block may be a voxel-ized point cloud with attribute information associated with the point cloud. For RGB color attributes, the input channel size may be 3. For reflectance in a LiDAR point cloud, the input channel size may be 1.

### Feature Encoder (FE)

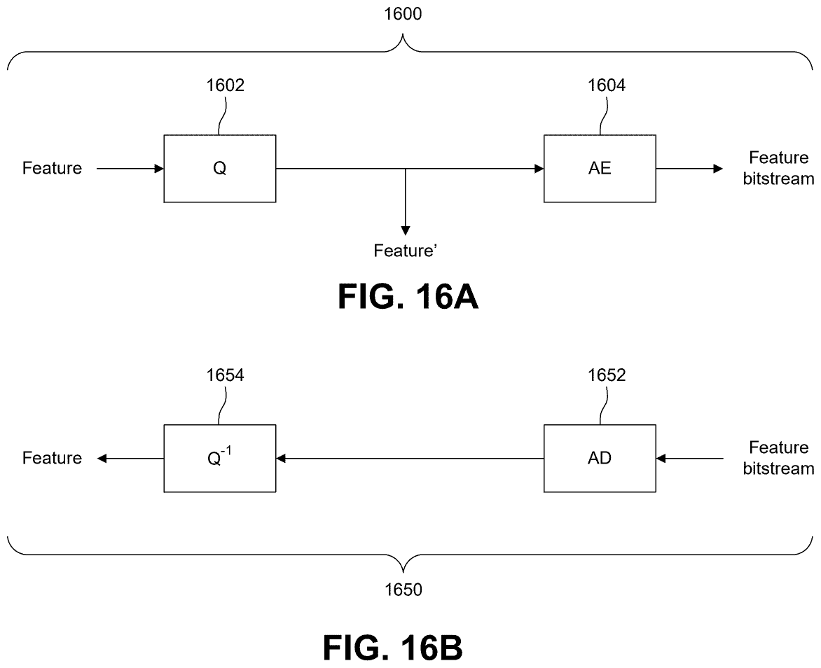

FIG. 16A is a process diagram illustrating an example feature encoder according to some embodiments. A feature encoder (FE) may be implemented in various ways. In FIG. 16A, a feature encoder 1600 is composed of two steps. In Step 1, a feature is passed through a quantization block 1602 based on a quantization step. The selection of quantization step is a pre-selected parameter based on a rate distortion requirement. In Step 2, the quantized feature is passed through an arithmetic encoder 1604 to generate a feature bitstream.

### Feature Decoder (FD)

FIG. 16B is a process diagram illustrating an example feature decoder according to some embodiments. In FIG. 16B, a feature decoder 1650 has decoding corresponding to the encoder of FIG. 16A. Firstly, the input bitstream is passed through an arithmetic decoder 1652. Next, a dequantization block 1654 outputs the decoded features.

### Attribute Probability Estimation (APE)

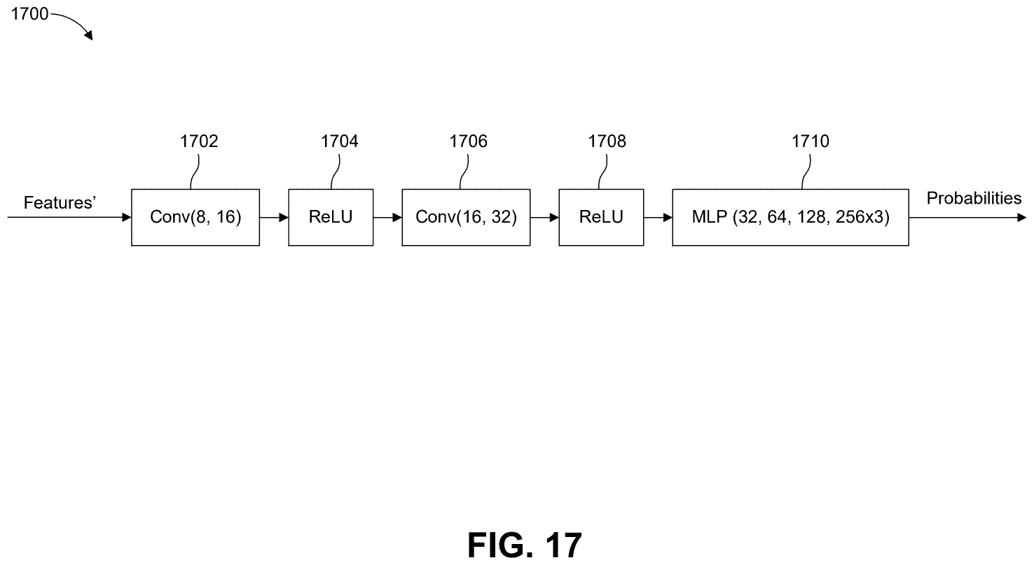

FIG. 17 is a process diagram illustrating an example attribute probability estimator according to some embodiments. An example design of the estimator (APE) 1700 is shown in FIG. 17. Firstly, the feature is further aggregated/refined by a few convolutional layers 1702, 1706 (two Conv layers in the example of FIG. 17) followed by rectifier linear unit (ReLU) blocks 1704, 1708. The aggregated feature is passed to a multilayer perceptron (MLP) 1710 to compute the probability. In FIG. 17, the term “(32, 64, 128, 256×3)” on the MLP block 1710 indicates the channel size for each of the MLP layers. In the end, the attribute probability distribution is a (256×3)-dimensional vector, which corresponds to probabilities of the values in range [0, 255] for the three RGB attribute channels. In other words, the first 256 numbers of the MLP output correspond to the probability distribution of the first color channel (e.g., R); the second group of 256 numbers correspond to the probability distribution of second color channel (e.g., G); and the last 256 numbers correspond to the probability distribution of the third color channel (e.g., B). For reflectance attributes of a LiDAR point cloud, the MLP output may be a 100-dimensional vector assuming there are 100 different reflectance intensity levels to be considered.

### Encoder

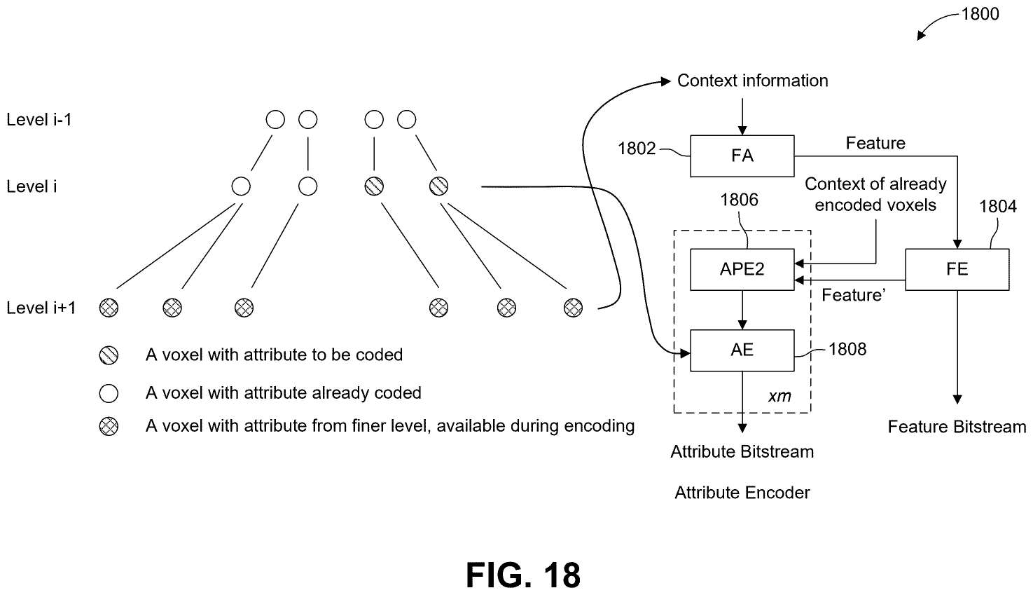

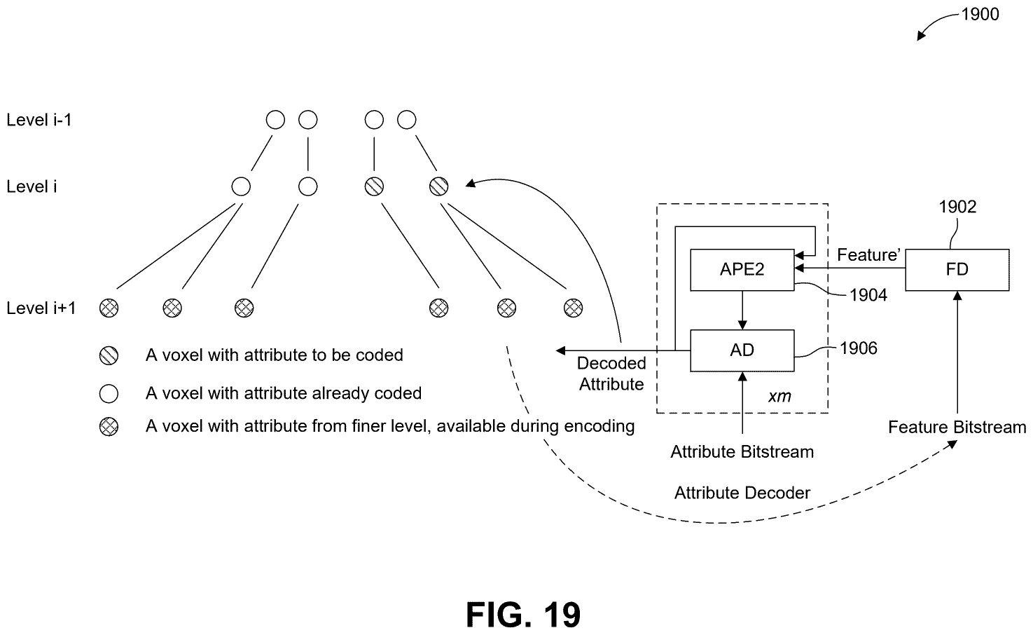

FIG. 18 is a process diagram illustrating an example application to attribute encoding according to some embodiments. The encoder diagram and the decoder diagram are provided in FIG. 18 and FIG. 19, respectively, where the APE2 block is the updated attribute probability estimation block mentioned earlier.

By comparing FIG. 18 with FIG. 13, the probability estimation and arithmetic encoding processes are repeated m times, where m is the number of steps to accomplish the encoding of the current LoD. In FIG. 18, the updated attribute probability estimation block (APE2) 1806 also takes an extra input, which is the context information of the already-encoded voxels at the current LoD. Based on the finer-level feature (Feature') and the context of the current LoD, APE2 (1806) estimates the probability distribution of the attributes to be encoded in the current step. In every iteration, the arithmetic encoder (AE) 1808 generates a bitstream. The bitstreams for all m steps are aggregated to form one bitstream representing the current LoD.

The context information for the already-encoded voxels contains at least the attribute information of these already-encoded voxels. In some embodiments, a neural network block may be applied to further extract another feature from the context information of the already encoded voxels. This process may be done to refine the context information before processing by the APE2 block.

Step 1 of the process 1800 is a feature extractor/aggregator (FA) 1802. The feature extractor/aggregator 1802 uses the finer (child) level of details as its input to extract a feature. Step 2 is a feature encoder (FE) 1804. The features generated from Step 1 are encoded into bitstreams. In addition to generating the bitstream, the feature encoder 1804 also outputs the reconstructed feature, which may not be exactly the same as the feature from Step 1. Steps 3 and 4 are the repetitive process described above.

### Decoder

FIG. 19 is a process diagram illustrating an example application to attribute decoding according to some embodiments.

By comparing FIG. 19 with FIG. 14, the probability estimation and arithmetic decoding processes are repeated m times during decoding. The updated attribute probability estimation block (APE2) 1904 takes an extra input—the context information of the already-decoded voxels of the current LoD. In this way, the decoded attribute of the current LoD is fed back to the APE2 block 1904 for the probability estimation of the next decoding step. The APE2 block 1904 also takes an input the decoded feature (“Feature′”). The feature decoder 1902 takes a feature bitstream as an input and outputs the decoded feature (“Feature′”). After each arithmetic decoding step, the arithmetic decoder 1906 outputs the attributes of the associated voxels. The attributes of all the voxels in the current level are obtained after all decoding steps are finished.

### Updated Attribute Probability Estimator (APE2)

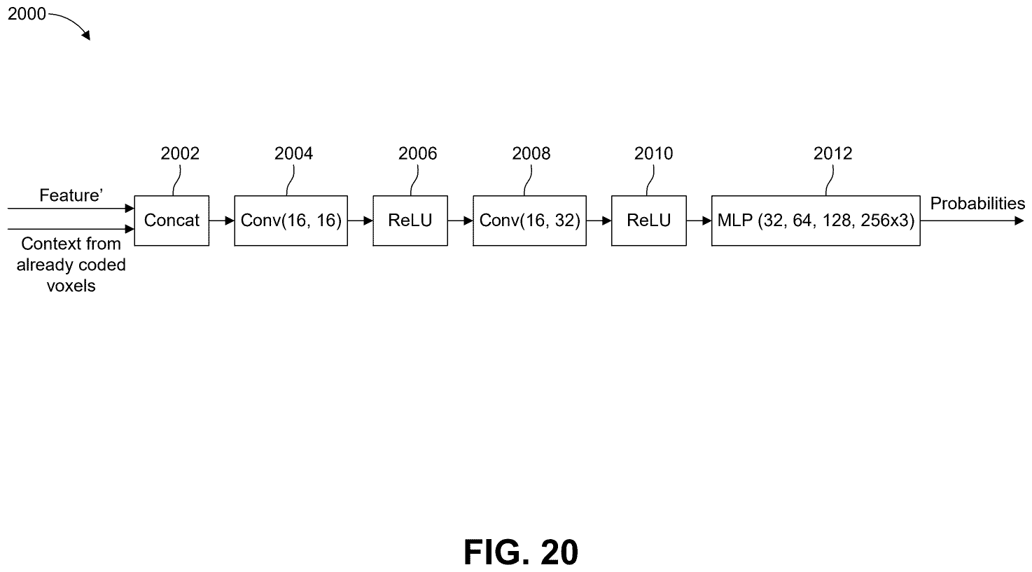

FIG. 20 is a process diagram illustrating an example updated attribute probability estimator according to some embodiments. An example design 2000 of the APE2 block is provided in FIG. 20. This example is similar to the APE block shown in FIG. 17. However, this design 2000 takes two inputs: the feature representing finer level information (Features'in FIG. 20) and the context information, which is also represented as a feature map. These two inputs are concatenated together by a concatenation process 2002 for the subsequent probability estimation process.

The feature is further aggregated/refined by a few convolutional layers 2004, 2008 (two Conv layers in the example of FIG. 20) followed by rectifier linear unit (ReLU) blocks 2006, 2010. The aggregated feature is passed to a multilayer perceptron (MLP) 2012 to compute the probability.

In lossless point cloud compression (either attribute or geometry) with an octree structure, the coding proceeds level-by-level. When coding one octree level, the probabilities of all the voxels to be coded may be estimated simultaneously, and then arithmetic coding may be performed with the estimated probabilities. To further utilize the correlations between the voxels, the one-step coding process may be broken into multiple steps so that the probability estimation of a voxel may be performed based on the already-coded voxels at the same level. This process may make the probability estimation more accurate for lossless coding and therefore make the bitstream size smaller. For some embodiments, this multi-step process may be applied to designs described in the '400 and '466 applications.

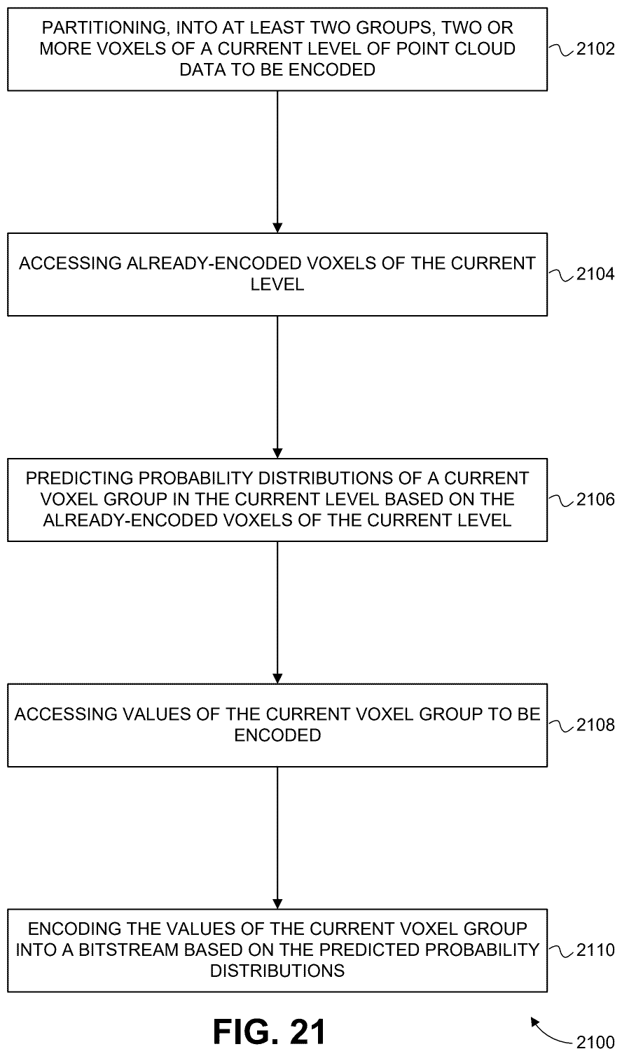

FIG. 21 is a flowchart illustrating an example encoding process according to some embodiments. For some embodiments, an example process 2100 may include partitioning 2102, into at least two groups, two or more voxels of a current level of point cloud data to be encoded. For some embodiments, the example process 2100 may further include accessing 2104 already-encoded voxels of the current level. For some embodiments, the example process 2100 may further include predicting 2106 probability distributions of a current voxel group in the current level based on the already-encoded voxels of the current level. For some embodiments, the example process 2100 may further include accessing 2108 values of the current voxel group to be encoded. For some embodiments, the example process 2100 may further include encoding 2110 the values of the current voxel group into a bitstream based on the predicted probability distributions.

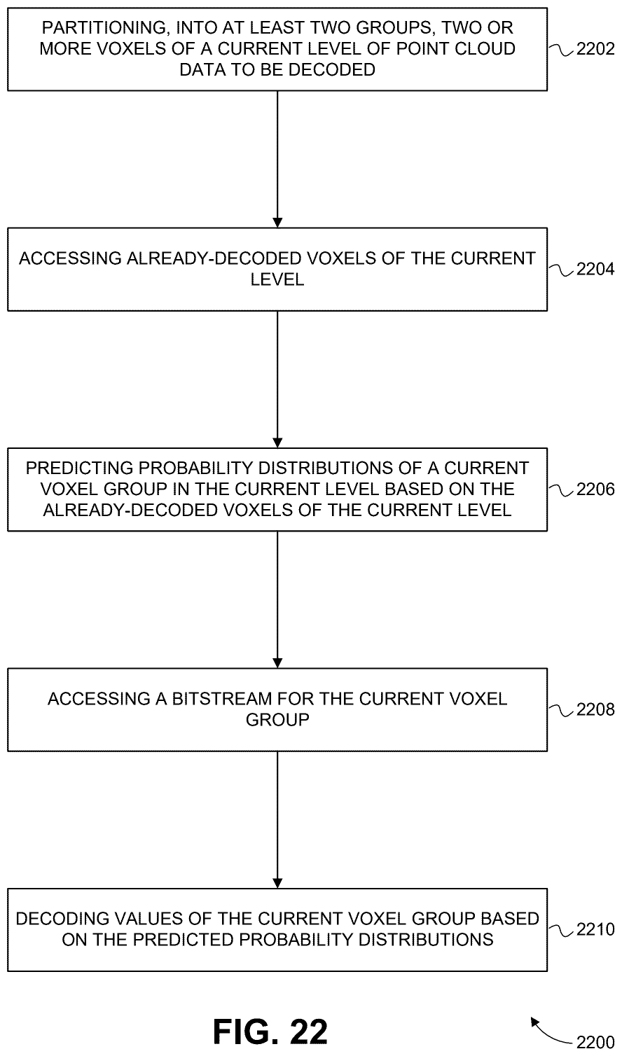

FIG. 22 is a flowchart illustrating an example decoding process according to some embodiments. For some embodiments, an example process 2200 may include partitioning 2202, into at least two groups, two or more voxels of a current level of point cloud data to be decoded. For some embodiments, the example process 2200 may further include accessing 2204 already-decoded voxels of the current level. For some embodiments, the example process 2200 may further include predicting 2206 probability distributions of a current voxel group in the current level based on the already-decoded voxels of the current level. For some embodiments, the example process 2200 may further include accessing 2208 a bitstream for the current voxel group. For some embodiments, the example process 2200 may further include decoding 2210 values of the current voxel group based on the predicted probability distributions.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: partitioning, into at least two groups, two or more voxels of a current level of point cloud data to be encoded; accessing already-encoded voxels of the current level; predicting probability distributions of a current voxel group in the current level based on the already-encoded voxels of the current level; accessing values of the current voxel group to be encoded; and encoding the values of the current voxel group into a bitstream based on the predicted probability distributions.

For some embodiments of the first example method, the values of the current voxel group are associated with color attributes related to the current voxel group.

For some embodiments of the first example method, the values of the current voxel group are associated with reflectance attributes of LiDAR data related to the current voxel group.

For some embodiments of the first example method, predicting probability distributions may include: convolutionally encoding one or more features, wherein the one or more features are derived from the already-encoded voxels of the current level; and passing the convolutionally encoded features through a multi-layer perceptron (MLP) to generate the predicted probability distributions.

Some embodiments of the first example method may further include concatenating at least one of the one or more features with context information obtained from the already-encoded voxels.

For some embodiments of the first example method, encoding the values of the current voxel group into the bitstream includes encoding the values of the current voxel group into the bitstream with arithmetic encoding based on the predicted probability distributions.

For some embodiments of the first example method, partitioning, into at least two groups, the two or more voxels of the current level includes splitting the voxels into two or more groups based on an associated attribute of one of the voxels.

For some embodiments of the first example method, partitioning, into at least two groups, the two or more voxels of the current level includes splitting the voxels into two or more groups based on an occupancy status of one of the voxels or a parent voxel of one of the voxels.

For some embodiments of the first example method, partitioning, into at least two groups, the two or more voxels of the current level includes splitting the voxels into two or more groups based on position of the two or more voxels relative to a parent voxel.

Some embodiments of the first example method may further include: performing a repetitive encoding process one or more times, wherein the repetitive encoding process includes: predicting current probability distributions of the current voxel group in the current level based on the already-encoded voxels of the current level; accessing values of the current voxel group to be encoded; and encoding the values of the current voxel group into a current output bitstream based on the current predicted probability distributions.

A second example method in accordance with some embodiments may include: partitioning, into at least two groups, two or more voxels of a current level of point cloud data to be decoded; accessing already-decoded voxels of the current level; predicting probability distributions of a current voxel group in the current level based on the already-decoded voxels of the current level; accessing a bitstream for the current voxel group; and decoding values of the current voxel group based on the predicted probability distributions.

For some embodiments of the second example method, the values of the current voxel group are associated with color attributes related to the current voxel group.

For some embodiments of the second example method, the values of the current voxel group are associated with reflectance attributes of LiDAR data related to the current voxel group.

For some embodiments of the second example method, predicting probability distributions includes: convolutionally encoding one or more features, wherein the one or more features are derived from the already-encoded voxels of the current level; and passing the convolutionally encoded features through a multi-layer perceptron (MLP) to generate the predicted probability distributions.

For some embodiments of the second example method, decoding the values of the current voxel group includes decoding the values of the current voxel group with arithmetic decoding based on the predicted probability distributions.

For some embodiments of the second example method, partitioning, into at least two groups, the two or more voxels of the current level includes splitting the voxels into two or more groups based on an associated attribute of one of the voxels.

For some embodiments of the second example method, partitioning, into at least two groups, the two or more voxels of the current level includes splitting the voxels into two or more groups based on an occupancy status of one of the voxels or a parent voxel of one of the voxels.

For some embodiments of the second example method, partitioning, into at least two groups, the two or more voxels of the current level includes splitting the voxels into two or more groups based on position of the two or more voxels relative to a parent voxel.

Some embodiments of the second example method may further include: performing a repetitive decoding process one or more times, wherein the repetitive decoding process includes: predicting current probability distributions of the current voxel group in the current level based on the already-decoded voxels of the current level; accessing a current attribute bitstream for the current voxel group; and decoding current values of the current voxel group based on the current predicted probability distributions.

An example apparatus in accordance with some embodiments may include: a processor; and a memory storing instructions operative, when executed by the processor, to cause the apparatus to: partition, into at least two groups, two or more voxels of a current level of point cloud data to be decoded; access already-decoded voxels of the current level; predict probability distributions of a current voxel group in the current level based on the already-decoded voxels of the current level; access a bitstream for the current voxel group; and decode values of the current voxel group based on the predicted probability distributions.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
partitioning, into at least two groups, two or more voxels of a current level of point cloud data to be encoded;
accessing already-encoded voxels of the current level;
predicting probability distributions of a current voxel group in the current level based on the already-encoded voxels of the current level;
accessing values of the current voxel group to be encoded; and
encoding the values of the current voxel group into a bitstream based on the predicted probability distributions.

2. The method of claim 1, wherein the values of the current voxel group are associated with color attributes related to the current voxel group.

3. The method of claim 1, wherein the values of the current voxel group are associated with reflectance attributes of LiDAR data related to the current voxel group.

4. The method of claim 1, wherein predicting probability distributions comprises:
convolutionally encoding one or more features,
wherein the one or more features are derived from the already-encoded voxels of the current level; and
passing the convolutionally encoded features through a multi-layer perceptron (MLP) to generate the predicted probability distributions.

5. The method of claim 4, further comprising concatenating at least one of the one or more features with context information obtained from the already-encoded voxels.

6. The method of claim 1, wherein encoding the values of the current voxel group into the bitstream comprises encoding the values of the current voxel group into the bitstream with arithmetic encoding based on the predicted probability distributions.

7. The method of claim 1, wherein partitioning, into at least two groups, the two or more voxels of the current level comprises splitting the voxels into two or more groups based on an associated attribute of one of the voxels.

8. The method of claim 1, wherein partitioning, into at least two groups, the two or more voxels of the current level comprises splitting the voxels into two or more groups based on an occupancy status of one of the voxels or a parent voxel of one of the voxels.

9. The method of claim 1, wherein partitioning, into at least two groups, the two or more voxels of the current level comprises splitting the voxels into two or more groups based on position of the two or more voxels relative to a parent voxel.

10. The method of claim 1, further comprising:
performing a repetitive encoding process one or more times,
wherein the repetitive encoding process comprises:
predicting current probability distributions of the current voxel group in the current level based on the already-encoded voxels of the current level;
accessing values of the current voxel group to be encoded; and
encoding the values of the current voxel group into a current output bitstream based on the current predicted probability distributions.

11. A method comprising:
partitioning, into at least two groups, two or more voxels of a current level of point cloud data to be decoded;
accessing already-decoded voxels of the current level;
predicting probability distributions of a current voxel group in the current level based on the already-decoded voxels of the current level;
accessing a bitstream for the current voxel group; and
decoding values of the current voxel group based on the predicted probability distributions.

12. The method of claim 11, wherein the values of the current voxel group are associated with color attributes related to the current voxel group.

13. The method of claim 11, wherein the values of the current voxel group are associated with reflectance attributes of LiDAR data related to the current voxel group.

14. The method of claim 11, wherein predicting probability distributions comprises:
convolutionally encoding one or more features,
wherein the one or more features are derived from the already-encoded voxels of the current level; and
passing the convolutionally encoded features through a multi-layer perceptron (MLP) to generate the predicted probability distributions.

15. The method of claim 11, wherein decoding the values of the current voxel group comprises decoding the values of the current voxel group with arithmetic decoding based on the predicted probability distributions.

16. The method of claim 11, wherein partitioning, into at least two groups, the two or more voxels of the current level comprises splitting the voxels into two or more groups based on an associated attribute of one of the voxels.

17. The method of claim 11, wherein partitioning, into at least two groups, the two or more voxels of the current level comprises splitting the voxels into two or more groups based on an occupancy status of one of the voxels or a parent voxel of one of the voxels.

18. The method of claim 11, wherein partitioning, into at least two groups, the two or more voxels of the current level comprises splitting the voxels into two or more groups based on position of the two or more voxels relative to a parent voxel.

19. The method of claim 11, further comprising:
performing a repetitive decoding process one or more times,
wherein the repetitive decoding process comprises:
predicting current probability distributions of the current voxel group in the current level based on the already-decoded voxels of the current level;
accessing a current attribute bitstream for the current voxel group; and
decoding current values of the current voxel group based on the current predicted probability distributions.

20. An apparatus comprising:
a processor; and
a memory storing instructions operative, when executed by the processor, to cause the apparatus to:
partition, into at least two groups, two or more voxels of a current level of point cloud data to be decoded;
access already-decoded voxels of the current level;
predict probability distributions of a current voxel group in the current level based on the already-decoded voxels of the current level;
access a bitstream for the current voxel group; and
decode values of the current voxel group based on the predicted probability distributions.
